(19) United States
(12) Patent Application Publication
(10) Pub. No.: US 2026/0044271 A1
(43) Pub. Date: Feb. 12, 2026

(54) SEMICONDUCTOR MEMORY DEVICE AND MEMORY SYSTEM

(71) Applicant: Samsung Electronics Co., Ltd., Suwon-si (KR)

(72) Inventors: Jongwon Kim, Suwon-si (KR); Joungyeal Kim, Suwon-si (KR); Chulung Kim, Suwon-si (KR); Doowon Bong, Suwon-si (KR)

(21) Appl. No.: 18/960,150

(22) Filed: Nov. 26, 2024

(30) Foreign Application Priority Data
Aug. 7, 2024 (KR) 10-2024-0105063

(51) Int. Cl. G06F 3/06

(52) U.S. Cl. CPC G06F 3/0625; G06F 3/0634; G06F 3/0673

(57) ABSTRACT

A semiconductor memory device includes a plurality of memory cells, a plurality of peripheral circuits, and a mode controller. The plurality of peripheral circuits perform a write operation for storing write data transmitted from a memory controller into the plurality of memory cells and a read operation for reading out read data of data stored in the plurality of memory cells to transfer the read data to the memory controller. The mode controller is configured to receive mode information from the memory controller, and, based on the mode information from the memory controller, control the plurality of peripheral circuits to operate in one of a normal mode for performing both the write operation and the read operation, a read-only mode for performing the read operation without performing the write operation, or a write-only mode for performing the write operation without performing the read operation.

### CROSS-REFERENCE TO RELATED APPLICATION

This U.S. non-provisional application claims priority under 35 USC § 119 to Korean Patent Application No. 10-2024-0105063, filed on Aug. 7, 2024, in the Korean Intellectual Property Office (KIPO), the disclosure of which is incorporated by reference herein in its entirety.

### FIELD

Example embodiments relate generally to semiconductor integrated circuits, and more particularly to a semiconductor memory device and a memory system.

### BACKGROUND

Semiconductor memory devices may be categorized into nonvolatile memory devices such as flash memory devices, and volatile memory devices such as dynamic random memory (DRAM) devices. The volatile devices are used to store large amounts of data, such as system memory, because they are relatively inexpensive. The volatile devices are gradually increasing in operation speed to improve performance, and as operation speed and memory capacity increase, power consumption increases. Especially in mobile devices powered by batteries, the increase in power consumption of semiconductor memory devices is a major cause of degradation of user experience.

### SUMMARY

Some example embodiments may provide a semiconductor memory device and a memory system, capable of reducing power consumption.

According to example embodiments, a semiconductor memory device includes a plurality of memory cells, a plurality of peripheral circuits and a mode controller. The plurality of peripheral circuits perform a write operation for storing write data transmitted from a memory controller into the plurality of memory cells and a read operation for reading out read data of data stored in the plurality of memory cells to transfer the read data to the memory controller.

The mode controller is configured to receive mode information from the memory controller, and, based on the mode information from the memory controller, control the plurality of peripheral circuits to operate in one of a normal mode for performing both the write operation and the read operation, a read-only mode for performing the read operation without performing the write operation, or a write-only mode for performing the write operation without performing the read operation.

According to example embodiments, a memory system includes a semiconductor memory device and a memory controller configured to control the semiconductor memory device. The semiconductor memory device includes a plurality of memory cells, a plurality of peripheral circuits configured to perform a write operation for storing write data transmitted from the memory controller into the plurality of memory cells and a read operation for reading out read data of data stored in the plurality of memory cells to transfer the read data to the memory controller, and a mode controller configured to receive mode information from the memory controller, and, based on the mode information from the memory controller, control the plurality of peripheral circuits to operate in one of a normal mode for performing both the write operation and the read operation, a read-only mode for performing the read operation without performing the write operation, or a write-only mode for performing the write operation without performing the read operation. The memory controller is configured to provide the semiconductor memory device with the mode information indicating one of the normal mode, the read-only mode, or the write-only mode, based on an access type with respect to the semiconductor memory device.

A semiconductor memory device includes a plurality of dynamic random access memory (DRAM) cells, read-only circuits that are used for a read operation for reading out read data of data stored in the plurality of DRAM cells to transfer the read data to a memory controller and are not used for a write operation for storing write data transmitted from the memory controller into the plurality of DRAM cells, write-only circuits that are used for the write operation and are not used for the read operation, and a mode controller configured to receive mode information from the memory controller, and, based on the mode information from the memory controller, enable both the read-only circuits and the write-only circuits in a normal mode that performs both the write operation and the read operation, disable the write-only circuits in a read-only mode that performs the read operation without performing the write operation, or disable the read-only circuits in a write-only mode that performs the write operation without performing the read operation.

The semiconductor memory device and the memory system according to example embodiments may reduce standby power of unnecessary circuits and reduce power consumption of the semiconductor memory device and the memory system by dynamically varying the operation mode of the semiconductor memory device depending on the type of access to the semiconductor memory device.

### BRIEF DESCRIPTION OF THE DRAWINGS

Example embodiments of the present disclosure will be more clearly understood from the following detailed description taken in conjunction with the accompanying drawings.

FIG. 1 is a block diagram illustrating a memory system according to example embodiments.

FIG. 2 is a diagram illustrating a transition of an operation mode of a semiconductor memory device according to example embodiments.

FIG. 3 is a state diagram illustrating a read-only mode of a semiconductor memory device according to example embodiments.

FIG. 4 is a state diagram illustrating a write-only mode of a semiconductor memory device according to example embodiments.

FIG. 5 is a block diagram illustrating a semiconductor memory device according to example embodiments.

FIG. 6 is a diagram illustrating a bank array included in a semiconductor memory device according to example embodiments.

FIG. 7 is a diagram illustrating an example of a mode register write command of a memory system according to example embodiments.

FIG. 8 is a diagram illustrating the providing of mode information in a memory system according to example embodiments.

FIG. 9 is a diagram illustrating a mode controller included in a semiconductor memory device according to example embodiments.

FIGS. 10 and 11 are timing diagrams illustrating example operations of the mode controller of FIG. 9.

FIG. 12 is a diagram illustrating an example of disabling circuits based on an operation mode of a semiconductor memory device according to example embodiments.

FIG. 13 is a diagram illustrating example embodiments of clock gating circuits included in a semiconductor memory device according to example embodiments.

FIG. 14 is a timing diagram illustrating operations of the clock gating circuit of FIG. 13.

FIG. 15 is a schematic diagram illustrating interfaces of a memory system according to example embodiments.

FIG. 16 is a block diagram illustrating an error check code (ECC) circuit included in a semiconductor memory device according to example embodiments.

FIG. 17 is a block diagram illustrating an example embodiment of an ECC engine included in the ECC circuit of FIG. 16.

FIG. 18 is a diagram illustrating an example embodiment of a parity generator included in the ECC engine of FIG. 17.

FIG. 19 is a diagram illustrating an example embodiment of a data corrector included in the ECC circuit of FIG. 16.

FIG. 20 is a diagram illustrating a memory system according to example embodiments.

FIGS. 21 through 24 are diagrams illustrating stacked memory devices according to example embodiments.

FIG. 25 is a structural diagram illustrating a semiconductor package including a semiconductor memory device according to example embodiments.

FIG. 26 is a block diagram illustrating a mobile system including a semiconductor memory device according to example embodiments.

### DETAILED DESCRIPTION OF THE EXAMPLE EMBODIMENTS

Various example embodiments will be described more fully hereinafter with reference to the accompanying drawings, in which some example embodiments are shown. In the drawings, like numerals refer to like elements throughout. The repeated descriptions may be omitted.

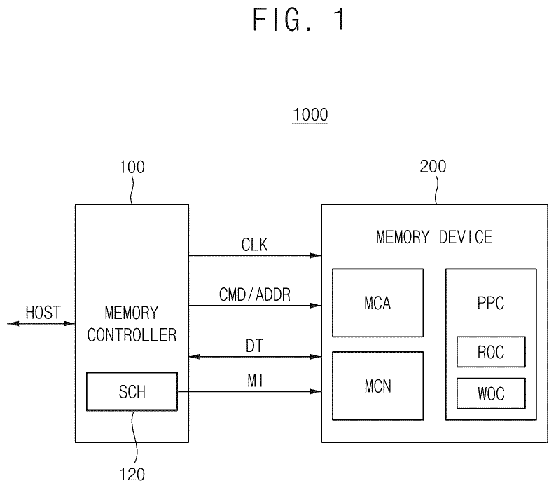

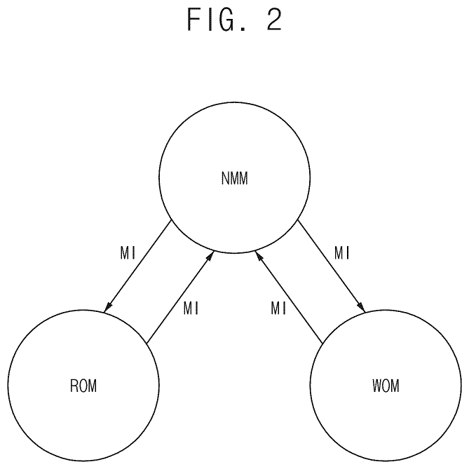

FIG. 1 is a block diagram illustrating a memory system according to example embodiments, and FIG. 2 is a diagram illustrating a transition of an operation mode of a semiconductor memory device according to example embodiments.

Referring to FIG. 1, a memory system 1000 may include a memory controller 100 and at least one semiconductor memory device 200.

The memory controller 100 controls the overall operation of the memory system 1000 and controls the overall data exchange between an external host device and the semiconductor memory device 200. For example, the memory controller 100 may control the semiconductor memory device 200 to write data or read data in response to a request from the host device.

According to example embodiments, the memory controller 100 may be included in a host device such as an application processor or a system-on-chip.

The memory controller 100 may issue operational commands to control the operation of the semiconductor memory device 200.

In some example embodiments, the semiconductor memory device 200 may be a dynamic random access memory (DRAM), synchronous DRAM (SDRAM), low power double data rate (LPDDR) SDRAM, or high bandwidth memory (HBM) having dynamic memory cells. In some example embodiments, the semiconductor memory device 200 may be a phase change random access memory (PRAM), a resistive random access memory (RRAM), a magnetic random access memory (MRAM), or a ferroelectric random access memory (FRAM). Example embodiments are not limited to these memories, and may be applied to any memory that performs read operations and write operations.

The memory controller 100 may transfer clock signals CLK, commands CMD, and addresses ADDR to the semiconductor memory device 200, and may transfer data DT to and from the semiconductor memory device 200.

The semiconductor memory device 200 may include a memory cell array MCA, a mode controller MCN including memory cells in which the data (DT) is stored, and peripheral circuits PPC.

The memory system 1000 may communicate with a host device using an interface protocol such as Peripheral Component Interconnect-Express (PCIe), Advanced Technology Attachment (ATA), Serial ATA (SATA), Parallel ATA (PATA), or serial attached SCSI (SAS), etc. The host device may determine and communicate an access type to the memory controller 100 when requesting access to the semiconductor memory device 200. The access type may be determined based on a system management scenario of the host device.

The memory controller 100 may include a mode scheduler (SCH) 120 that determines an operation mode of the memory system 1000 based on access types provided by the host device or determined by the memory management scenario of the memory controller 100. The mode scheduler (SCH) 120 may generate mode information MI indicating the determined operation mode, and the memory controller 100 may provide the mode information MI to the semiconductor memory device 200.

The peripheral circuits PPC may, under control of the memory controller 100, perform a write operation of storing input data transmitted from the memory controller 100 into the memory cells of the memory cell array MCA and a read operation of reading out data stored in the memory cells to transfer the read data to the memory controller 100. In addition, the peripheral circuits PPC may perform various other operations required by the type of semiconductor memory device 200.

Based on the mode information MI provided by the memory controller 100, the mode controller MCN may control the peripheral circuits PPC in an operation mode corresponding to the mode information MI.

Referring to FIG. 2, the operation mode of the semiconductor memory device 200 may include a normal mode NMM, a read-only mode ROM, and a write-only mode WOM. The semiconductor memory device 200 may perform both write operations and read operations in the normal mode NMM. In contrast, the semiconductor memory device 200 may perform read operations without performing write operations in the read-only mode ROM and write operations without performing read operations in the write-only mode WOM.

If the mode information MI changes to a value indicating the read-only mode ROM during the normal mode NMM, the mode controller MCN may change the operation mode of the peripheral circuits PPC from the normal mode NMM to the read-only mode ROM. After that, if the mode information MI changes back to a value indicating the normal mode NMM, the mode controller MCN may restore the operation mode of the peripheral circuits PPC from the read-only mode ROM to the normal mode NMM.

Further, if the mode information MI changes to a value indicating write-only mode WOM during the normal mode NMM, the mode controller MCN may change the operation mode of the peripheral circuits PPC from the normal mode NMM to the write-only mode WOM. After that, if the mode information MI changes back to the value indicating normal mode NMM, the mode controller MCN may restore the operation mode of the peripheral circuits PPC from the write-only mode WOM to the normal mode NMM.

As shown in FIG. 1, the peripheral circuits PPC may include read-only circuits ROC and write-only circuits WOC. The read-only circuits ROC correspond to circuits that are used for read operations and are not used for write operations. On the other hand, the write-only circuits WOC correspond to circuits that are used for write operations and are not used for read operations. As will be described below, the read-only circuits ROC may include transmission circuits that transmit the read data from the semiconductor memory device 200 to the memory controller 100, an ECC decoder that performs error check code (ECC) decoding on the read data, and the like, and the write-only circuits WOC may include reception circuits that receive the write data transmitted from the memory controller 100, an ECC encoder that performs ECC encoding on the write data, and the like.

The mode controller MCN may, based on the mode information MI, disable the write-only circuits WOC in the read-only mode ROM and disable the write-only circuits ROC in the write-only mode WOM. In other words, the read-only circuits ROC may be enabled in the normal mode NMM and the read-only mode ROM and disabled in the write-only mode WOM. On the other hand, the write-only circuits WOC may be enabled in the normal mode NMM and the write-only mode WOM and disabled in the read-only mode ROM. Other peripheral circuits PPC that do not correspond to the read-only circuits ROC and write-only circuits WOC may be enabled in the normal mode NMM, the read-only mode ROM, and the write-only mode WOM.

In some example embodiments, the read-only circuits ROC or the write-only circuits WOC may be disabled by disabling the clock signals applied to the read-only circuits ROC or the write-only circuits WOC, respectively. In other words, the mode controller MCN may, based on the mode information MI, disable the clock signals applied to the read-only circuits ROC in the write-only mode WOM and disable the clock signals applied to the write-only circuits WOC in the read-only mode ROM.

In some example embodiments, the read-only circuits ROC or the write-only circuits WOC may be disabled by blocking the power supply voltage applied to the read-only circuits ROC or the write-only circuits WOC, respectively. In other words, the mode controller MCN may, based on the mode information MI, block the power supply voltage applied to the read-only circuits ROC in the write-only mode WOM and block the power supply voltage applied to the write-only circuits WOC in the read-only mode ROM. A power supply voltage may be blocked in many ways, including, but not limited to, disconnecting the power source, using a switch to control the flow of power to the circuit, increasing the resistance of a variable resistor, or inserting a blocking diode to prevent current from flowing in the direction that would power the circuit. Embodiments of the present disclosure that may block a power supply voltage are not limited to the above methods.

According to example embodiments, the read-only circuits ROC or the write-only circuits WOC may be disabled by simultaneously blocking the power supply voltage and/or disabling the clock signal. A circuit may be disabled in many ways, including, but not limited to, blocking the power supply, disabling the clock signal, disabling the input line, or shorting any of the above to ground. Embodiments of the present disclosure that may disable, for example, a read-only circuit or a write-only circuit are not limited to the above methods.

By disabling the write-only circuits WOC in the read-only mode ROM, the standby power of the write-only mode WOM may be reduced, and by disabling the read-only circuits ROC in the write-only mode WOM, the standby power of the read-only mode ROM may be reduced.

Depending on the application running on the host device, access to the semiconductor memory device 200 may be concentrated for read operations or concentrated for write operations. In this case, the standby power of the read-only circuits ROC that are not used for read operations and the standby power of the write-only circuits WOC that are not used for write operations constitutes unnecessary power consumption.

For example, if the host device uses the semiconductor memory device 200 to run artificial intelligence (AI), the write operation is initially intensive to load data, such as variables of an artificial neural network, into the semiconductor memory device 200. Subsequently, for each token generation, the entirety of the data that was written to the semiconductor memory device 200 is read out, with very few write operations occurring. Depending on this type of access, if the read operation is intensive, for example, in the early stages of the AI's execution, the read-only mode ROM may be performed to disable the write-only circuits WOC to prohibit the write operation. In contrast, if the read operation is intensive, for example, at each token generation, the write-only mode WOM may be performed to disable the write-only circuits ROC to prohibit the read operation.

As such, the semiconductor memory device 200 and the memory system 1000 according to example embodiments may dynamically vary the operation mode of the semiconductor memory device 200 to either the read-only mode ROM or the write-only mode WOM depending on the type of access to the semiconductor memory device 200, thereby reducing the standby power of unnecessary circuits and reducing the power consumption of the semiconductor memory device 200 and the memory system 1000.

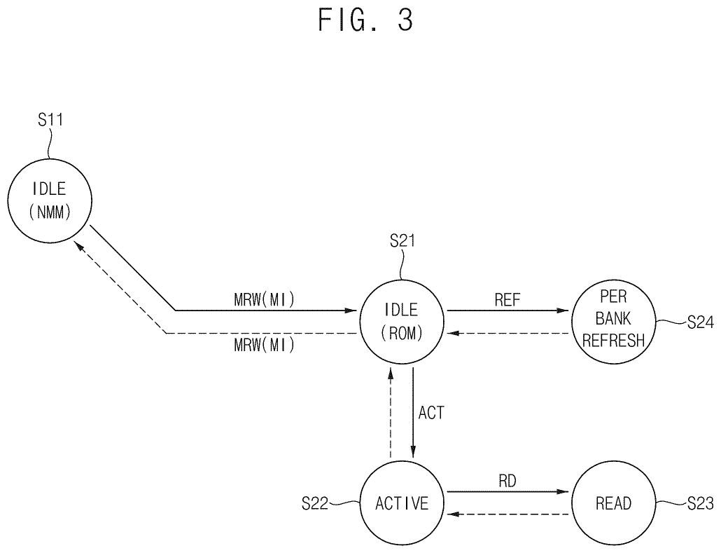

FIG. 3 is a state diagram illustrating a read-only mode of a semiconductor memory device according to example embodiments.

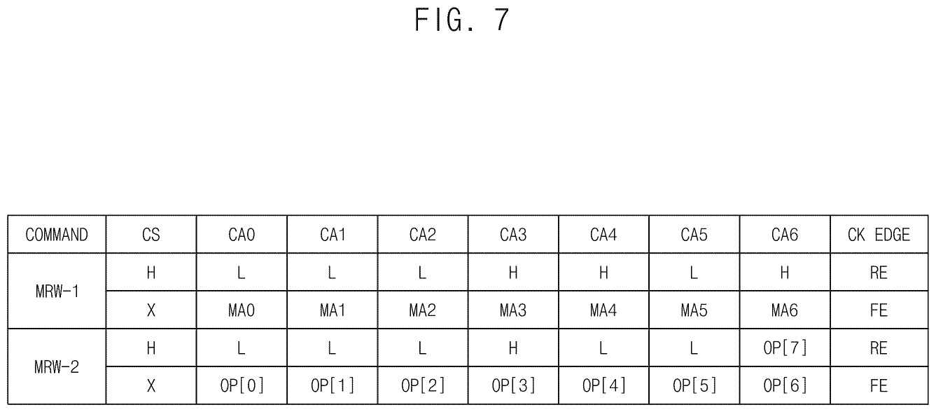

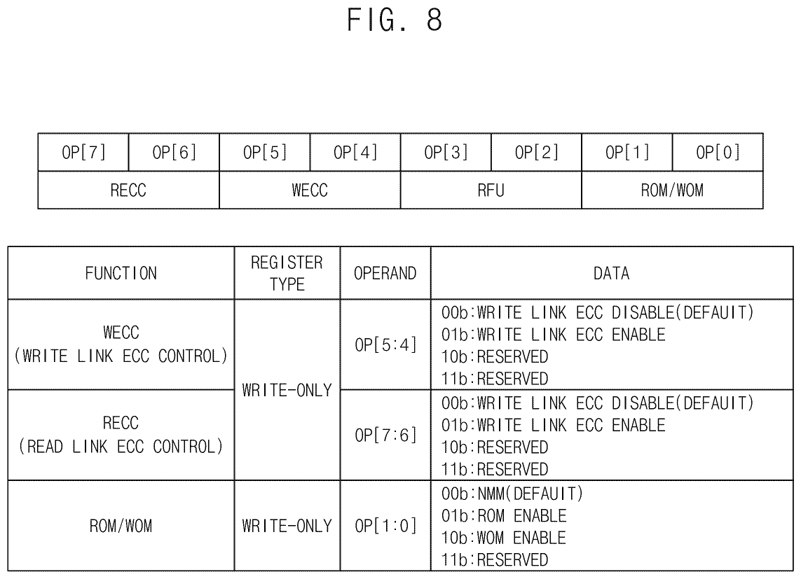

Referring to FIGS. 1 and 3, the semiconductor memory device 200 may transition to an idle state (S21) of the read-only mode ROM when the mode information MI changes to a value indicating the read-only mode ROM during an idle state (S11) of the normal mode NMM. In an example embodiment, as will be described below with reference to FIGS. 7 and 8, the mode information MI may be provided to the semiconductor memory device 200 via a mode register write command MRW transmitted from the memory controller 100.

The semiconductor memory device 200 may switch from the idle state (S21) of the read-only mode ROM to an active state (S22) by enabling a selected wordline according to an active command ACT transmitted from the memory controller 100, and may subsequently receive a read command RD to perform a read operation (S23) to read data from the selected memory cells. On the other hand, the semiconductor memory device 200 may perform a bank-by-bank refresh operation (S24) in response to a refresh command REF transmitted from the memory controller 100 in the idle state (S21) of the read-only mode ROM.

As such, in the read-only mode ROM, the semiconductor memory device 200 may receive the active command ACT, the read command RD, the refresh command REF, and the mode register write command MRW, and may be prohibited from receiving other commands.

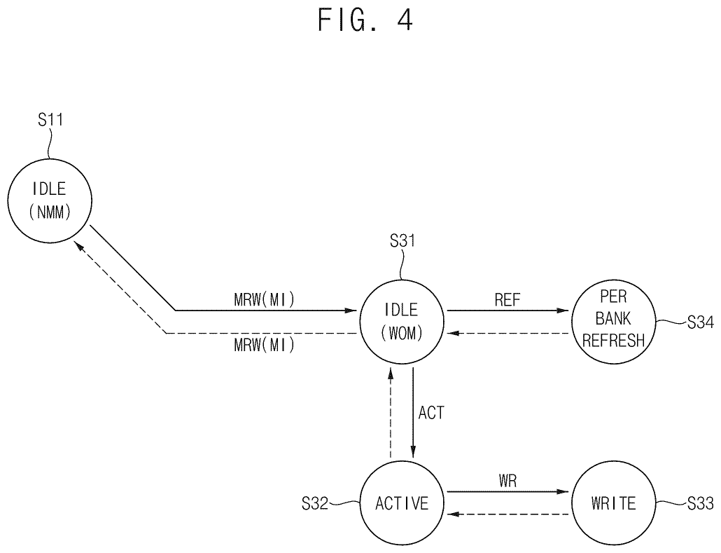

FIG. 4 is a state diagram illustrating a write-only mode of a semiconductor memory device according to example embodiments.

Referring to FIGS. 1 and 4, the semiconductor memory device 200 may transition to an idle state (S31) of the write-only mode WOM if the mode information MI changes to a value indicating the write-only mode WOM during the idle state (S11) of the normal mode NMM. In an example embodiment, as will be described below with reference to FIGS. 7 and 8, the mode information MI may be provided to the semiconductor memory device 200 via a mode register write command MRW transmitted from the memory controller 100.

The semiconductor memory device 200 may, in the idle state (S31) of the write-only mode WOM, enable a selected wordline according to an active command ACT transmitted from the memory controller 100 to switch to an active state (S32) and subsequently receive a write command WR to perform a write operation (S33) to write data to the selected memory cells. The semiconductor memory device 200 may perform a bank-by-bank refresh operation (S34) in response to a refresh command REF transmitted from the memory controller 100 in the idle state (S31) of the write-only mode WOM.

As such, in the write-only mode WOM, the semiconductor memory device 200 may receive the active commands ACT, the write commands WR, the refresh commands REF, and the mode register write commands MRW and may be inhibited from receiving other commands.

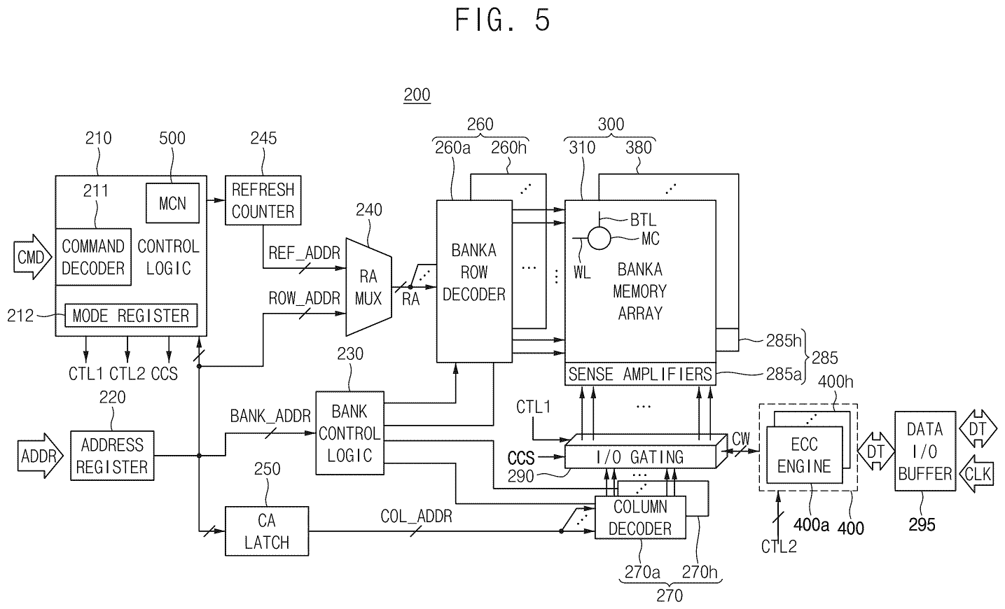

FIG. 5 is a block diagram illustrating a semiconductor memory device according to example embodiments.

Referring to FIG. 5, a semiconductor memory device 200 includes control logic circuit 210, an address register 220, a bank control logic 230, a refresh counter 245, and a row address multiplexer 240, a column address latch 250, a row decoder 260, a column decoder 270, a memory cell array 300, a sense amplifier circuit 285, an input-output gating circuit 290, an ECC circuit 400, and a data input-output buffer 295. Here, the other circuits except for the memory cell array 300 may correspond to the peripheral circuits PPC described above.

The ECC circuit 400 may include first, second, third, fourth, fifth, sixth, seventh, and eighth ECC engines 400a, 400b, 400c, 400d, 400e, 400f, 400g, and 400h, and the input-output gating circuit 290 may include a plurality of input-output gating circuits corresponding to each of the bank arrays.

The memory cell array 300 may include the first, second, third, fourth, fifth, sixth, seventh, and eighth bank arrays 310, 320, 330, 340, 350, 360, 370, and 380. The row decoder 260 may include first, second, third, fourth, fifth, sixth, seventh, and eighth bank row decoders 260a, 260b, 260c, 260d, 260e, 260f, 260g, and 260h connected to the first, second, third, fourth, fifth, sixth, seventh, and eighth bank arrays 310, 320, 330, 340, 350, 360, 370, and 380, respectively, and the column decoder 270 may include first, second, third, fourth, fifth, sixth, seventh, and eighth bank column decoders 270a, 270b, 270c, 270d, 270e, 270f, 270g, and 270h connected to the first, second, third, fourth, fifth, sixth, seventh, and eighth bank arrays 310, 320, 330, 340, 350, 360, 370, and 380, respectively, the sense amplifier circuit 285 may include first, second, third, fourth, fifth, sixth, seventh, and eighth bank sense amplifiers 285a, 285b, 285c, 285d, 285e, 285f, 285g, and 285h connected to the first, second, third, fourth, fifth, sixth, seventh, and eighth bank arrays 310, 320, 330, 340, 350, 360, 370, and 380, respectively. The first, second, third, fourth, fifth, sixth, seventh, and eighth bank arrays 310, 320, 330, 340, 350, 360, 370, and 380, the first, second, third, fourth, fifth, sixth, seventh, and eighth bank sense amplifiers 285a, 285b, 285c, 285d, 285e, 285f, 285g, and 285h, the first, second, third, fourth, fifth, sixth, seventh, and eighth bank column decoders 270a, 270b, 270c, 270d, 270e, 270f, 270g, and 270h, and the first, second, third, fourth, fifth, sixth, seventh, and eighth bank row decoders 260a, 260b, 260c, 260d, 260e, 260f, 260g, and 260h may each form the first, second, third, fourth, fifth, sixth, seventh, and eighth banks. Each of the first, second, third, fourth, fifth, sixth, seventh, and eighth bank arrays 310, 320, 330, 340, 350, 360, 370, and 380 may include a plurality of wordlines WL, a plurality of bitlines BTL, and a plurality of memory cells MC formed at intersections of the wordlines WL and the bitlines BTL.

The address register 220 may receive an address ADDR from the memory controller 100 that includes a bank address BANK_ADDR, a row address ROW_ADDR, and a column address COL_ADDR. The address register 220 may provide the received bank address BANK_ADDR to the bank control logic 230, the received row address ROW_ADDR to the row address multiplexer 240, and the received column address COL_ADDR to the column address latch 250.

The bank control logic 230 may generate bank control signals in response to the bank address BANK_ADDR. In response to the bank control signals, the bank row decoder corresponding to the bank address BANK_ADDR of the first, second, third, fourth, fifth, sixth, seventh, and eighth bank row decoders 260a, 260b, 260c, 260d, 260e, 260f, 260g, and 260h may be activated, and the bank column decoder corresponding to the bank address BANK_ADDR of the first, second, third, fourth, fifth, sixth, seventh, and eighth bank column decoders 270a, 270b, 270c, 270d, 270e, 270f, 270g, and 270h may be activated.

The row address multiplexer 240 may receive the row address ROW_ADDR from the address register 220 and a refresh row address REF_ADDR from the refresh counter 245. The row address multiplexer 240 may selectively output the row address ROW_ADDR or the refresh row address REF_ADDR as the row address RA. The row address RA output from the row address multiplexer 240 may be applied to each of the first, second, third, fourth, fifth, sixth, seventh, and eighth bank row decoders 260a through 260h.

Among the first, second, third, fourth, fifth, sixth, seventh, and eighth bank row decoders 260a, 260b, 260c, 260d, 260e, 260f, 260g, and 260h, the bank row decoder enabled by the bank control logic 230 may decode the row address RA output from the row address multiplexer 240 to enable a wordline corresponding to the row address. For example, the activated bank row decoder may apply a wordline drive voltage to the wordline corresponding to the row address.

The column address latch 250 may receive the column address COL_ADDR from the address register 220 and may temporarily store the received column address COL_ADDR. Additionally, the column address latch 250 may increase the received column address COL_ADDR incrementally, in burst mode. The column address latch 250 may apply the temporarily stored or incrementally incremented column address COL_ADDR to the first, second, third, fourth, fifth, sixth, seventh, and eighth bank column decoders 270a, 270b, 270c, 270d, 270e, 270f, 270g, and 270h, respectively.

Among the first, second, third, fourth, fifth, sixth, seventh, and eighth bank column decoders 270a, 270b, 270c, 270d, 270e, 270f, 270g, and 270h, the bank column decoder enabled by the bank control logic 230 may activate the sense amplifier corresponding to the bank address BANK_ADDR and column address COL_ADDR via the input-output gating circuit 290. The input-output gating circuit 290 may include, in addition to circuits for gating input and output data, input data mask logic, read data latches for storing data output from the first, second, third, fourth, fifth, sixth, seventh, and eighth bank arrays 310 through 380, and write drivers for writing data to the first, second, third, fourth, fifth, sixth, seventh, and eighth bank arrays 310 through 380.

The codeword CW that is read out from one of the first, second, third, fourth, fifth, sixth, seventh, and eighth bank arrays 310, 320, 330, 340, 350, 360, 370, and 380 may be detected by a sense amplifier corresponding to the one bank array and stored in the read data latches. The codeword CW stored in the read data latches may be provided to the memory controller 100 via the data input-output buffer 295 after ECC decoding is performed by a corresponding ECC engine. The data DT to be written to one of the first, second, third, fourth, fifth, sixth, seventh, and eighth bank arrays 310, 320, 330, 340, 350, 360, 370, and 380 may be written to the one bank array via the write drivers after ECC encoding is performed by the corresponding ECC engine.

The data input-output buffer 295 may provide the data DT to the ECC circuit 400 based on a clock signal CLK provided from the memory controller 100 in the write operation, and may provide the data DT from the ECC circuit 400 to the memory controller 100 in the read operation.

In the write operation, the ECC circuit 400 may generate parity bits based on the data bits of the data DT provided from the data input-output buffer 295, and provide the codeword CW including the data DT and the parity bits to the input-output gating circuit 290, and the input-output gating circuit 290 may write the codeword CW to a corresponding bank array.

The ECC circuit 400 may also receive from the input-output gating circuit 290 the codeword CW that has been read out from one bank array in the read operation. The ECC circuit 400 may perform ECC decoding on the data DT using parity bits included in the codeword CW to correct errors in the data DT and provide the corrected data to the data input-output buffer 295.

The control logic circuit 210 may control the operations of the semiconductor memory device 200. For example, the control logic circuit 210 may generate control signals to cause the semiconductor memory device 200 to perform the write operation or the read operation. The control logic circuit 210 may include a command decoder 211 that decodes commands CMD received from the memory controller 100, a mode controller MCN 500 that controls the operation mode of the semiconductor memory device 200, and a mode register set 212 that stores values for controlling the operations of the semiconductor memory device 200.

The command decoder 211 may decode the commands CMD transmitted from the memory controller and generate control signals CTL1, CTL2 and CCS corresponding to the command CMD.

As described above, the mode controller MCN may control the peripheral circuits to operate in one of the normal mode, the read-only mode, and the write-only mode based on the mode information provided from the memory controller. FIG. 5 illustrates, but is not limited to, an example embodiment in which the mode controller MCN is included in the control logic circuit 210. In some example embodiments, the mode controller MCN may be implemented as a separate logic circuit distinct from the control logic circuit 210.

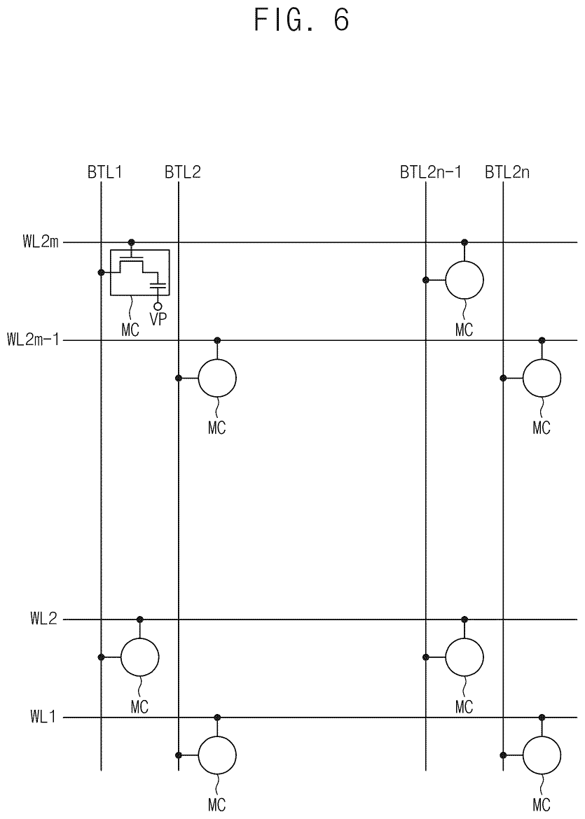

FIG. 6 is a diagram illustrating an example embodiment of a bank array included in a semiconductor memory device according to example embodiments.

Referring to FIG. 6, a bank array includes a plurality of wordlines WL1 to WL2m, where m is an integer, a plurality of bitlines BTL1 to BTL2n, where n is an integer, and a plurality of memory cells MC disposed at intersections between the wordlines WL1 to WL2m and the bitlines BTL1 to BTL2n. As shown in FIG. 6, each memory cell MC may have a DRAM cell structure. The memory cell MCs may include a cell capacitor connected to a plate voltage VP and a cell transistor connected between each bitline and the cell capacitor and the gate of the cell transistor is connected to each wordline. The wordlines to which the memory cells MC are connected may be defined as rows of the bank array, and the bitlines to which the memory cells MC are connected may be defined as columns of the bank array.

The semiconductor memory device according to example embodiments may be a DRAM device as described with reference to FIGS. 5 and 6, but example embodiments are not limited to any particular type of memory.

FIG. 7 is a diagram illustrating an example of a mode register write command of a memory system according to example embodiments.

In FIG. 7, a combination of a chip select signal CS and command-address signals CA0, CA1, CA2, CA3, CA4, CA5, and CA6 is illustrated to represent, as an example, a mode register write command MRW according to the low power double data rate 5 (LPDDR5) standard. H indicates logic high level, L indicates logic low level, X indicates that it may be logic low level or logic high level, MA0, MA1, MA2, MA3, MA4, and MA5 indicate the location of the mode register where the mode register write operation is to be performed, OP[0] through OP[7] indicate the information to be written to the mode register, and RE and FE indicate rising and falling edges of the clock signal CK.

The mode register write command MRW may include a first portion MRW-1 and a second portion MRW-2 and may be transmitted during a plurality of clock cycles (e.g., two clock cycles). The mode register write command MRW may include mode register location information MA0, MA1, MA2, MA3, MA4, and MA5 and the mode information OP0, OP[1], OP[2], OP[3], OP[4], OP[5], OP[6], and OP[7]. The combination of the chip select signal CS and command-address signals CA0, CA1, CA2, CA3, CA4, CA5, and CA6 shown in FIG. 7 is an example, and the combination of signals representing the code may be varied.

FIG. 8 is a diagram illustrating an example embodiment of providing mode information in a memory system according to example embodiments.

FIG. 8 illustrates, as an example, information stored in one mode register MR22 according to the LPDDR5 standard. According to the LPDDR5 standard, operands OP[5:4] of the mode register MR22 correspond to control values WECC for write link ECC control and operands OP[7:6] correspond to control values RECC for read link ECC control. The remaining operands OP[3:0] are reserved for future use RFU.

According to example embodiments, the operations of these reserved mode registers may be utilized to store the aforementioned mode information MI. For example, as shown in FIG. 8, two operations OP[1:0] may be used as mode information MI indicating the normal mode NMM, the read-only mode ROM, or the write-only mode WOM.

In some example embodiment, as shown in FIG. 8, the mode information MI may include a first bit OP[0] indicating the read-only mode ROM and a second bit OP[1] indicating the write-only mode WOM. The mode information MI may indicate the normal mode NMM when both the first bit OP[0] and the second bit OP[1] have a first value (e.g., a value of ‘0’), the read-only mode ROM when the first bit OP[0] has a second value (e.g., a value of ‘1’), and the write-only mode WOM when the second bit OP[1] has the second value.

As such, the peripheral circuits PPC of FIG. 1 may include mode registers (e.g., the mode register set 212 in FIG. 5) that store control values for controlling the operation of the semiconductor memory device 200, and the semiconductor memory device 200 may receive the mode information MI via a mode register write command MRW transmitted from the memory controller 100 and store the mode information MI in a mode register among the mode register set 212.

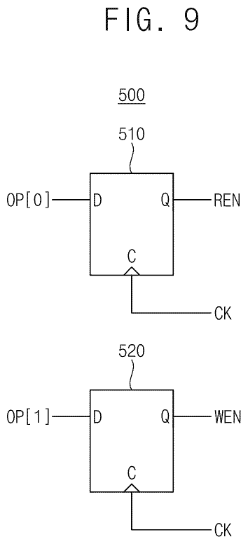

FIG. 9 is a diagram illustrating an example embodiment of a mode controller included in a semiconductor memory device according to example embodiments.

Referring to FIG. 9, the mode controller 500 may generate a read-only mode enable signal REN indicating the read-only mode ROM and a write-only mode enable signal WEN indicating the write-only mode WOM, based on the mode information MI stored in one of the mode registers, such as the first bit OP[0] and the second bit OP[1] of FIG. 8.

The mode controller 500 may include a first signal generator 510 and a second signal generator 520. The first signal generator 510 may generate the read-only mode enable signal REN that is activated during the read-only mode ROM based on the clock signal CK and the first bit OP[0] of the mode information MI. The second signal generator 520 may generate the write-only mode enable signal WEN that is activated during the write-only mode WOM based on the clock signal CK and the second bit OP[1] of the mode information MI.

In some example embodiments, as shown in FIG. 9, the first signal generator 510 and the second signal generator 520 may include flip-flops. The first signal generator 510 may sample the logic value of the first bit OP[0] applied to the data terminal D in synchronization with an edge of the clock signal CK applied to the clock terminal C to generate the read-only mode enable signal REN output through the output terminal Q. The second signal generator 520 may sample the logic value of the second bit OP[1] applied to the data terminal D in synchronization with an edge of the clock signal CK applied to the clock terminal C to generate the write-only mode enable signal WEN output through the output terminal Q.

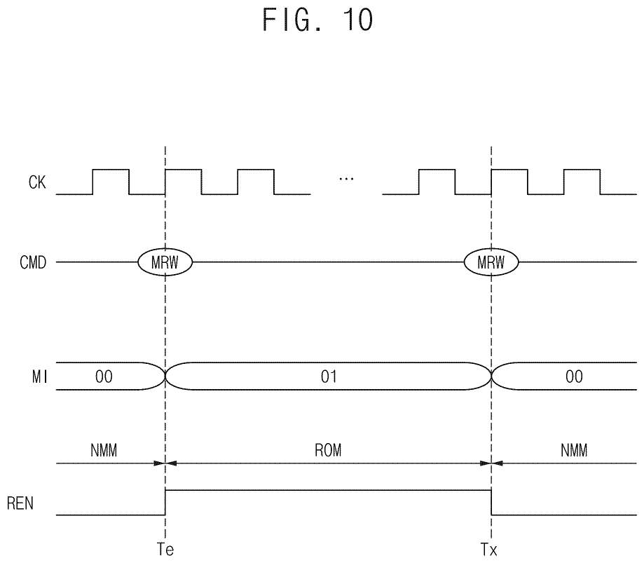

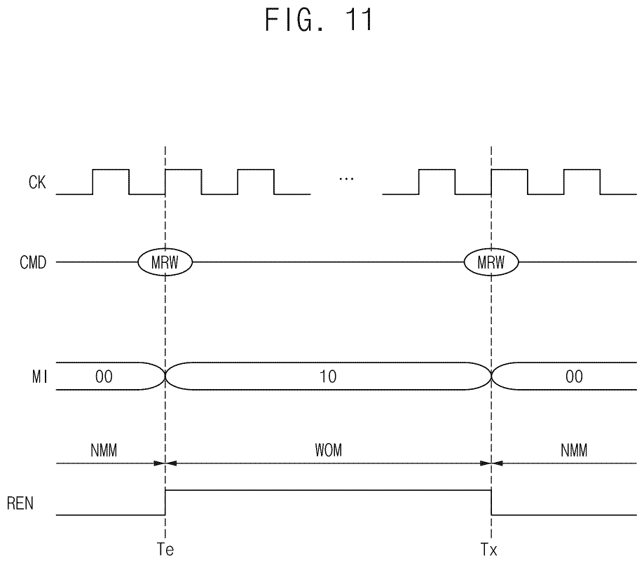

FIGS. 10 and 11 are timing diagrams illustrating example operations of the mode controller of FIG. 9.

Referring to FIG. 10, based on a mode register write command MRW transmitted from the memory controller at a first time point Te, the mode information MI may be changed from a value of “00” indicating the normal mode NMM to a value of “01” indicating the read-only mode ROM. Then, based on another mode register write command MRW transmitted from the memory controller at a second time point Tx, the mode information MI may be changed from the value of “01” indicating the read-only mode ROM back to the value of “00” indicating the normal mode NMM. As a result, the first signal generator 510 of FIG. 9 may generate the read-only mode enable signal REN indicating the read-only mode ROM.

Referring to FIG. 11, based on a mode register write command MRW transmitted from the memory controller at a first time point Te, the mode information MI may change from a value of “00” indicating the normal mode NMM to a value of “10” indicating the write-only mode WOM. Then, based on another mode register write command MRW transmitted from the memory controller at a second time point Tx, the mode information MI may change from the value of “10” indicating the write-only mode WOM back to the value of “00” indicating the normal mode NMM. As a result, the second signal generator 520 of FIG. 9 may generate the write-only mode enable signal WEN indicating the write-only mode WOM.

FIGS. 10 and 11 illustrate, but are not limited to, example embodiments in which the read-only mode enable signal REN and the write-only mode enable signal WEN are activated in a logic high level. Depending on the configuration of the circuit, the read-only mode enable signal REN and/or the write-only mode enable signal WEN may be implemented as being activated in a logic low level.

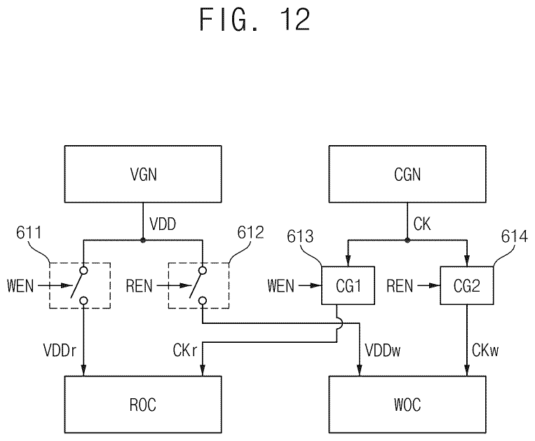

FIG. 12 is a diagram illustrating an example of disabling circuits based on an operation mode of a semiconductor memory device according to example embodiments.

Referring to FIG. 12, the aforementioned peripheral circuits PPC may include a voltage generator VGN, a clock generator CGN, read-only circuits ROC and write-only circuits WOC.

The voltage generator VGN may generate a power supply voltage VDD for operation of the peripheral circuits PPC based on an external power supply voltage. The clock generator CGN may generate a clock signal CK for operation of the peripheral circuits PPC based on an external clock signal transmitted from the memory controller for synchronization with the memory controller.

The read-only circuits ROC correspond to circuits that are used for read operations and are not used for write operations. On the other hand, the write-only circuits WOC correspond to circuits that are used for write operations and are not used for read operations.

In some example embodiments, the peripheral circuits PPC may include a first voltage switch circuit 611 and a second voltage switch circuit 612. The first voltage switch circuit 611 may block a power supply voltage VDDr applied to the read-only circuits ROC in response to activation of the write-only mode enable signal WEN. The second voltage switch circuit 612 may block a power supply voltage VDDw applied to the write-only circuits WOC in response to activation of the read-only mode enable signal REN.

In some example embodiments, the peripheral circuits PPC may include a first clock gating circuit (CG1) 613 and a second clock gating circuit (CG2) 614. The first clock gating circuit 613 may disable a clock signal CKr applied to the read-only circuits ROC in response to activation of the write-only mode enable signal WEN. The second clock gating circuit 614 may disable a clock signal CKw applied to the write-only circuits WOC in response to activation of the read-only mode enable signal REN.

As such, disabling the write-only circuits WOC during the read-only mode ROM and disabling the read-only circuits ROC during the write-only mode WOM may be implemented by blocking the power supply voltage and/or disabling the clock signal applied to the read-only circuits ROC and the write-only circuits WOC, respectively.

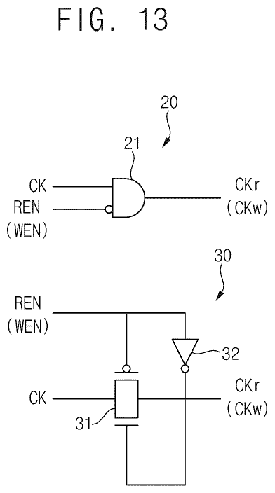

FIG. 13 is a diagram illustrating example embodiments of clock gating circuits included in a semiconductor memory device according to example embodiments.

The clock gating circuits 20 and 30 in FIG. 13 correspond to example embodiments of the first clock gating circuit 613 and second clock gating circuit 614 of FIG. 12.

The first clock gating circuit 613 may gate a clock signal CK based on the write-only mode enable signal WEN to generate a clock signal CKr for operation of the read-only circuits ROC. The second clock gating circuit 614 may gate the clock signal CK based on the read-only mode enable signal REN to generate a clock signal CKw for operation of the write-only circuits WOC.

In some example embodiments, the clock gating circuit 20 may be implemented as a logic gate, for example, a logic AND gate 21. The logic AND gate 21 may perform a logic AND operation on the clock signal CK and an inversion signal of the read-only mode enable signal REN (or the write-only mode enable signal WEN) to generate a clock signal CKr that is applied to the read-only circuits ROC (or a clock signal CKw that is applied to the write-only circuits WOC).

In some example embodiments, the clock gating circuit 30 may be implemented as a transfer gate 31 and an inverter 32. The transfer gate 31 may selectively pass a clock signal CK based on the read-only mode enable signal REN (or the write-only mode enable signal WEN) to generate a clock signal CKr that is applied to the read-only circuits ROC (or a clock signal CKw that is applied to the write-only circuits WOC).

FIG. 14 is a timing diagram illustrating operations of the clock gating circuit of FIG. 13.

Referring to FIG. 14, the clock signal CK may be blocked by the clock gating circuit as described with reference to FIG. 13 during the time period Te to Tx when the read-only mode enable signal REN (or the write-only mode enable signal WEN) is activated. As a result, the clock signal CKr applied to the read-only circuits ROC (or the clock signal CKw applied to the write-only circuits WOC) may cease toggling and become inactive during the time period Te through Tx corresponding to the read-only mode ROM (or the write-only mode WOM).

In this way, the read-only circuits ROC or write-only circuits WOC may be selectively disabled based on the read-only mode enable signal REN and the write-only mode enable signal WEN generated by the mode controller MCN based on the mode information MI.

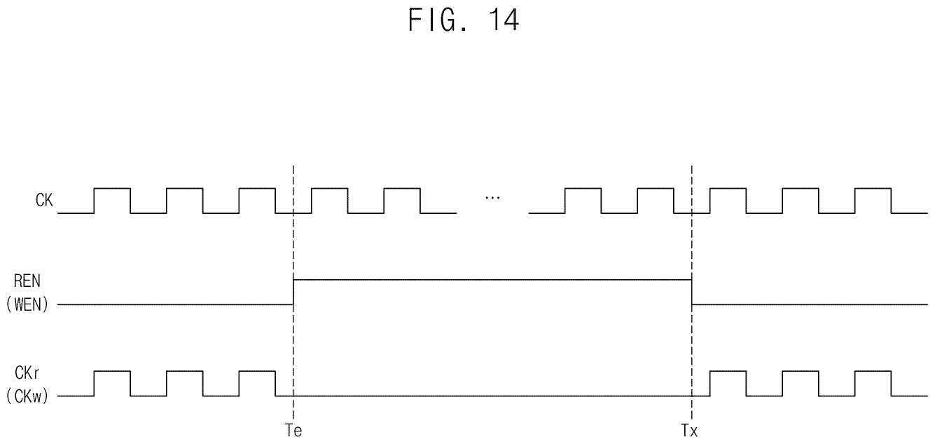

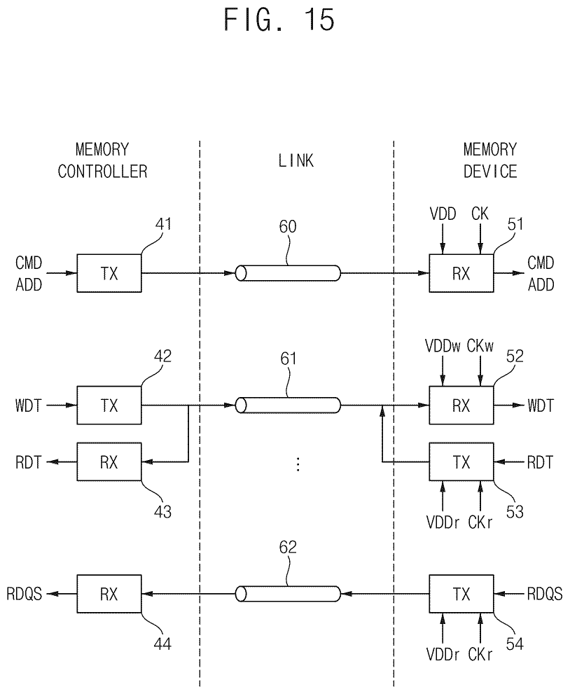

FIG. 15 is a schematic diagram illustrating interfaces of a memory system according to example embodiments.

Referring to FIG. 15, a memory controller and a semiconductor memory device may communicate with each other via a link comprising a plurality of conductive paths 60, 61 and 62. The memory controller and the semiconductor memory device may include transmission circuits TX and reception circuits RX for communicating with each other.

For example, the memory controller may include transmission circuits 41 for transmitting commands CMD and addresses ADD to the semiconductor memory device, transmission circuits 42 for transmitting write data WDT to the semiconductor memory device, reception circuits 43 for receiving read data RDT from the semiconductor memory device, and reception circuits 44 for receiving read strobe signals RDQS from the semiconductor memory device. Complementary to the configuration of the memory controller, the semiconductor memory device may include reception circuits 51 for receiving the commands CMD and the addresses ADD from the memory controller, reception circuits 52 for receiving the write data WDT from the memory controller, transmission circuits 53 for transmitting the read data RDT to the memory controller, and transmission circuits 54 for transmitting the read strobe signals RDQS to the memory controller.

In the semiconductor memory device, the reception circuits 52 correspond to the write-only circuits WOC described above and the transmission circuits 53 and 54 correspond to the read-only circuits ROC described above.

Referring to FIGS. 12 and 15, the reception circuits 52 corresponding to the read-only circuits ROC may be applied the power supply voltage VDDr corresponding to the output of the first voltage switch circuit 611 and the clock signal CKr corresponding to the output of the first clock gating circuit 613. As a result, in the write-only mode WOM, the reception circuits 52 may be disabled and the standby power consumption of the reception circuits 52 may be reduced.

On the other hand, the transmission circuits 53 and 54 corresponding to the write-only circuits WOC may be applied the power supply voltage VDDw corresponding to the output of the second voltage switch circuit 612 and the clock signal CKw corresponding to the output of the second clock gating circuit 614. As a result, in the read-only mode ROM, the transmission circuits 53 and 54 may be disabled and the standby power consumption of the transmission circuits 53 and 54 may be reduced.

The reception circuits 51 that receive the commands CMD and the addresses ADD are used for both the read and write operations. Therefore, the reception circuits 51 may be applied with the power supply voltage VDD and the clock signal CK independent of the read-only mode ROM and the write-only mode WOM.

While the operation modes of the semiconductor memory device have been described with reference to FIG. 15, similar operation mode may be applied to the circuits of a memory controller. In other words, by applying the configurations and methods described above, the transmission circuits 42 of the memory controller may be disabled in the read-only mode ROM and the reception circuits 43 and 44 of the memory controller may be disabled in the write-only mode WOM.

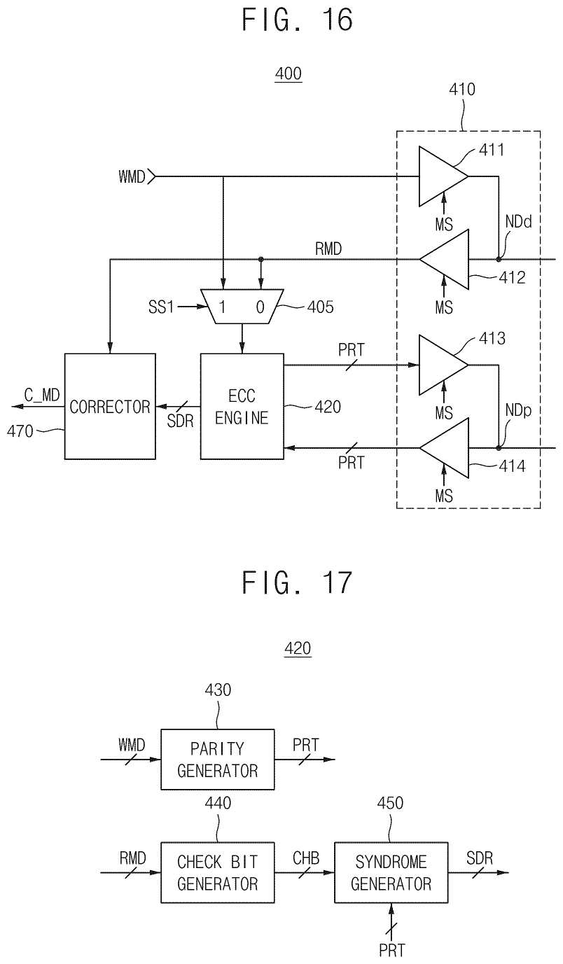

FIG. 16 is a block diagram illustrating an example embodiment of an error check code (ECC) circuit included in a semiconductor memory device according to example embodiments.

Referring to FIG. 16, an ECC circuit 400 may include a multiplexer 405, an ECC engine 420, a buffer circuit 410, and a data corrector 470. The buffer circuit 410 may include first, second, third, and fourth buffers 411˜414.

In response to a select signal SS1, the multiplexer 405 may provide write data WMD to the ECC engine 420 in a write operation and read data RMD provided from the buffer 412 in a read operation.

The buffers 411 and 413 may be enabled in the write operation in response to a mode signal MS and may provide the write data WMD and parity data PRT to input-output gating circuit 290 via data nodes NDd and parity nodes NDp. The buffers 412 and 414 are enabled in the read operation in response to the mode signal MS, and the buffer 412 may provide read data RMD to the multiplexer 405 and data corrector 470 via the data node NDd, and the buffer 414 may provide the parity data PRT to the ECC engine 420 via the parity node NDp.

In the write operation, the ECC engine 420 may perform ECC encoding on the write data WMD to provide the parity data PRT to the buffer 413. In the read operation, the ECC engine 420 may perform ECC decoding on the read data RMD provided from the multiplexer 405 based on the parity data PRT provided from the buffer 414 to provide syndrome data SDR to the data corrector 470.

The data corrector 460 may correct errors in the read data RMD based on the syndrome data SDR provided from the ECC engine 420 to provide corrected data C_MD.

In FIG. 16, the select signal SS1 and the mode signal MS may be included in the second control signal CTL2 provided from the control logic circuit 210 of FIG. 5.

FIG. 17 is a block diagram illustrating an example embodiment of an ECC engine included in the ECC circuit of FIG. 16.

Referring to FIG. 17, the ECC engine 420 may include a parity generator 430, a check bit generator 440 and a syndrome generator 450.

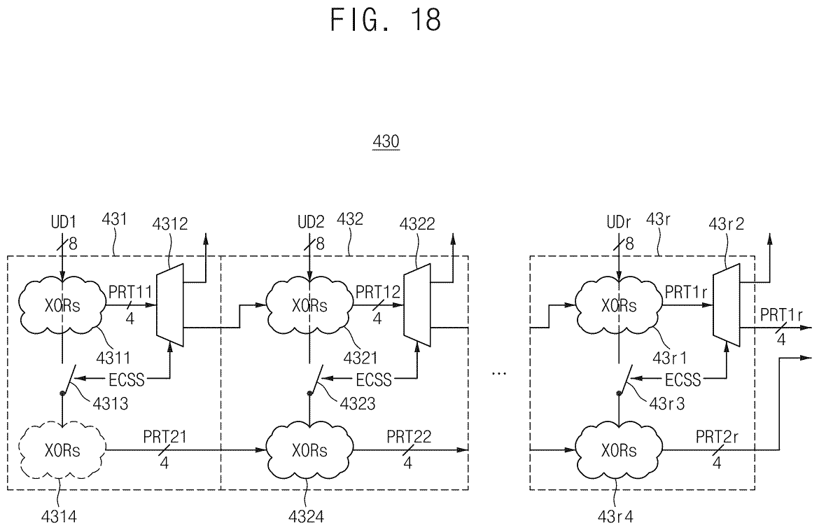

The parity generator 430 may include an array of exclusive OR gates to generate the parity data PRT based on the write data WMD. The parity generator 430 may include unit generators that operate in unison or separately, as will be further described below with reference to FIG. 18.

The check bit generator 440 may generate check bits CHB based on the read data RMD. The check bit generator 440 may include unit generators that operate in unison or separately.

The syndrome generator 450 may generate the syndrome data SDR based on the check bits CHB based on the read data RMD and the parity data PRT provided from the buffer 444.

The syndrome generator 450 may include a plurality of unit generators, and the number of the plurality of unit generators enabled may be reconfigured based on the on-die ECC level assigned.

FIG. 18 is a diagram illustrating an example embodiment of a parity generator included in the ECC engine of FIG. 17.

Referring to FIG. 18, the parity generator 430 may include a plurality of unit generators 431˜43r.

The unit generators 431˜43r may operate in conjunction with each other in a first engine configuration mode in response to an engine configuration select signal ECSS, and may operate separately in a second engine configuration mode.

The unit generators 431˜43r may include first XOR modules 4311˜43r1, demultiplexers 4312˜43r2, switches 4313˜43r3, and second XOR modules 4314-43r4, respectively.

The first XOR modules 4311˜43r1 may perform an XOR operation on a corresponding one of the unit data UD1˜UDr to generate first partial parity data PRT11˜PRT1r, respectively.

The switches 4313˜43r3 may each provide a corresponding one of the unit data UD1˜UDr in the first engine configuration mode to a corresponding one of the second XOR modules 4314˜43r4 in response to the engine configuration select signal ECSS, and may be open in the second engine configuration mode. The second XOR modules 4314˜43r4 may be sequentially connected in the first engine configuration mode to perform an XOR operation on a corresponding one of the unit data UD1˜UDr to sequentially generate the second partial parity data PRT21˜PRT2r.

The demultiplexers 4312˜43r2 may provide the first partial parity data PRT11˜PRT1r in a first path when a relatively high on-die ECC level is set in response to the engine configuration select signal ECSS, and the first partial parity data PRT11˜PRT1r in a second path when a relatively high on-die ECC level is set. Here, the first path is a path that causes the unit generators 431˜43r to be sequentially connected to each other, and the second path is a path that causes the unit generators 431˜43r to be isolated from each other and not connected.

In FIG. 18, the engine configuration select signal ECSS may be included in the second control signal CTL2 provided from the control logic circuit 210 of FIG. 5.

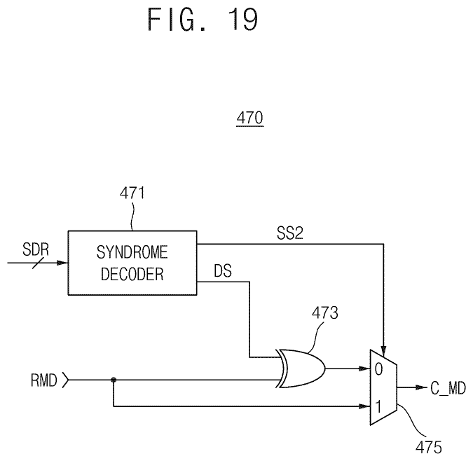

FIG. 19 is a diagram illustrating an example embodiment of a data corrector included in the ECC circuit of FIG. 16.

Referring to FIG. 19, the data corrector 470 may include a syndrome decoder 471, a bit inverting circuit 473, and a selection circuit 475 implemented as a multiplexer.

The syndrome decoder 471 may decode the syndrome data SDR to generate a decoding signal DS indicating the location of the at least one error bit and a select signal SS2 having a logic level based on the number of the at least one error bit. The bit inverting circuit 473 may invert the one error bit in response to the decoding signal DS. The selection circuit 475 may provide one of the read data RMD and the output of the bit inverting circuit 473 as the corrected data C_MD in response to the select signal SS2.

The syndrome decoder 471 may output the select signal SS2 at the first logic level if the number of at least one error bits included in the read data RMD based on the syndrome data SDR exceeds the error-correctable range of the ECC. The selection circuit 475 may output the read data RMD as the corrected data C_MD in response to the select signal SS2 at the first logic level. The syndrome decoder 471 may output the decoding signal DS at the first logic level and the select signal SS2 at the second logic level if the number of at least one error bits included in the read data RMD based on the syndrome data SDR is within the error-correctable range of the ECC. The bit inverting circuit 473 may invert the at least one error bit in response to the decoding signal DS at the first logic level. The selection circuit 475 may output the output of the bit inverting circuit 473 as the corrected data C_MD in response to the select signal SS2 at the second logic level.

The components described with reference to FIGS. 16 through 19 may be grouped into an ECC encoder that performs ECC encoding on the write data WMD and an ECC decoder that performs ECC decoding on the read data RMD. In other words, the buffers 411 and 413 and the parity generator 430 correspond to the ECC encoder, and the buffers 412 and 414, the check bit generator 440, the syndrome generator 450 and the data corrector 470 correspond to the ECC decoder. The components such as buffer 411, buffer 413 and parity generator 430 forming the ECC encoder correspond to the write-only circuits WOC that are used for write operations and are not used for read operations. On the other hand, the components such as buffer 412, buffer 414, check bit generator 440, syndrome generator 450 and data corrector 470 forming the ECC decoder correspond to the read-only circuits ROC that are used for read operations and are not used for write operations.

As described above, the mode controller MCN may, based on the mode information MI, disable the ECC encoders including buffer 411, buffer 413 and parity generator 430 collectively corresponding to the write-only circuits WOC in the read-only mode ROM and disable the ECC decoders including buffer 412, buffer 414, check bit generator 440, syndrome generator 450 and data corrector 470 corresponding to the read-only circuits ROC in the write-only mode WOM.

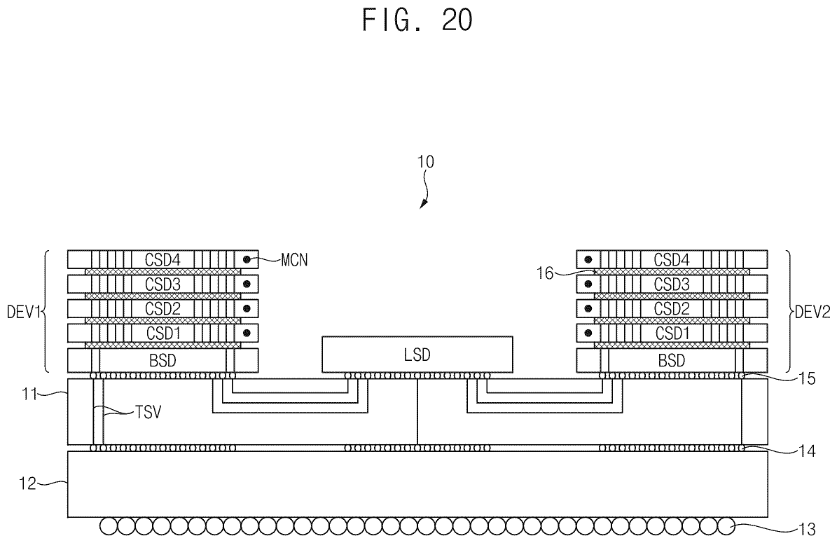

FIG. 20 is a diagram illustrating a memory system according to example embodiments.

Referring to FIG. 20, a memory system may be implemented in a multi-chip package 10. The multi-chip package 10 includes a package substrate 12 and an interposer 11 mounted on the package substrate 12. The interposer 11 may be electrically coupled to the package substrate 12 via C4 bumps 14, pads, or any other conductive contact. The package substrate 12 may be connected to an external device via contact means 13 formed on its underside, such as balls in a ball grid array (BGA). The interposer 11 includes a metal layer forming conductive traces through silicon vias (TSV) and/or other conductive contacts or interconnections. Conductive interconnects within the interposer provide connections for devices mounted on the interposer 11 and/or conductive contacts on the package substrate 12. For example, the interposer 11 may include interconnects for connecting a logic die LSD to memory devices, such as HBM stacks DEV1 and DEV2. The interposer 11 may include an active device (e.g., a die that includes transistors or other active components) or a passive device (e.g., a die that does not include active components). For example, the HBM stacks DEV1 and DEV2 may be connected to the logic die LSD via a bridge die (e.g., an embedded multi-die interconnect bridge (EMIB)) or via another technique for combining chips in a multi-chip package. Although two HBM stacks DEV1 and DEV2 are shown, the multi-chip package 10 may include a single HBM stack or more HBM stacks.

The multi-chip package 10 includes the logic die LSD mounted on the interposer 11. The logic die LSD may be or include a system on a chip (SoC), a field programmable gate array (FPGA), a central processing unit (CPU), an accelerator, a graphics processing unit (GPU), or other logic die. The logic die LSD is coupled to the HBM stacks DEV1 and DEV2 through an interconnection of the interposer 11, an EMIB, or other interconnection between the logic die LSD and the HBM stacks DEV1 and DEV2. As illustrated in FIG. 20, each of the HBM stacks DEV1 and DEV2 include a base semiconductor die BSD and a plurality of memory semiconductor dies or a plurality of core semiconductor dies CSD1, CSD2, CSD3, AND CSD4 that are stacked in a vertical direction. The base semiconductor die BSD and the plurality of core semiconductor dies CSD1, CSD2, CSD3, AND CSD4 are electrically connected to each other through a plurality of vertical conductive paths including through-silicon vias (TSV). The memory cells are distributed and arranged on a plurality of core semiconductor dies CSD1, CSD2, CSD3, AND CSD4. The HBM stacks DEV1 and DEV2 may be internally and externally connected through contact means 15 and 16, for example, micro bumps.

The above-described mode controllers MCN may be arranged on each of the plurality of core semiconductor dies CSD1, CSD2, CSD3, AND CSD4. In this case, according to the independent control of the mode controllers MCN, mode information for each of the plurality of core semiconductor dies CSD1, CSD2, CSD3, AND CSD4 is received from the logic die LSD performing the function of the memory controller, and each core semiconductor die may independently operate in one of the normal mode, the read-only mode and the write-only mode.

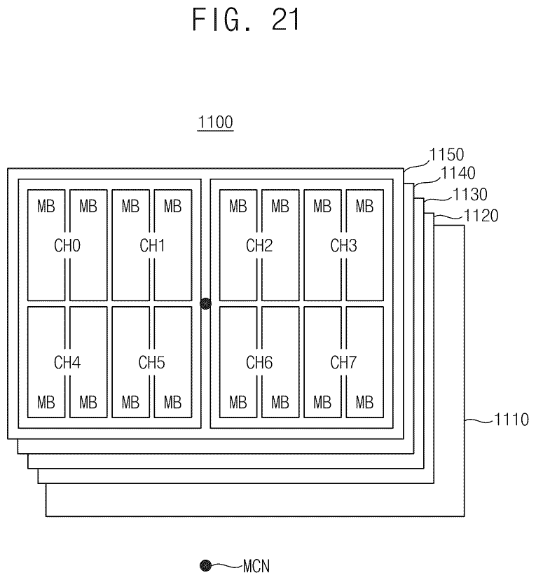

FIGS. 21 through 24 are diagrams illustrating stacked memory devices according to example embodiments.

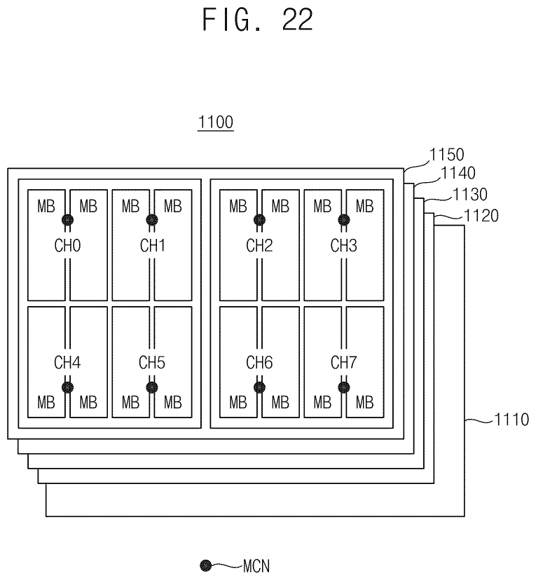

FIGS. 21 and 22 illustrate an example of the structure of a high-bandwidth memory.

Referring to FIGS. 21 and 22, a high bandwidth memory (HBM) 1100 may include a structure in which a plurality of DRAM semiconductor dies 1120, 1130, 1140 and 1150 are stacked. The plurality of DRAM semiconductor dies 1120, 1130, 1140 and 1150 correspond to the core semiconductor dies described above.

The high bandwidth memory may be optimized for high bandwidth operation of the stacked structure through a plurality of independent interfaces called channels. According to the HBM standard, each DRAM stack may support a variety of channels.

Although FIGS. 21 and 22 illustrate an example in which four DRAM semiconductor dies are stacked, example embodiments are not limited thereto. Each semiconductor die may provide additional capacity and additional channels to the stacked structure. Each channel provides access to an independent set of DRAM banks. A request from one channel does not access data attached to another channel. The channels are independently clocked and do not need to be synchronized with each other. FIGS. 21 and 22 illustrate an example in which the memory banks MB of each DRAM semiconductor die are grouped into eight independent channels CH0˜CH7, but example embodiments are not limited thereto. The high bandwidth memory 1100 may include a buffer die or interface die 1110 located at the bottom of the stack structure and providing signal redistribution and other functions. Functions typically implemented in the DRAM semiconductor dies 1120, 1130, 1140 and 1150 may be implemented in this interface die 1110. According to example embodiments, the high bandwidth memory 1100 may include one or more mode controllers MCN included in the plurality of DRAM semiconductor dies 1120, 1130, 1140 and 1150.

In some example embodiments, as illustrated in FIG. 21, each DRAM semiconductor die may include a mode controller MCN. In this case, the high bandwidth memory 1100 may receive mode information for each of the plurality of DRAM semiconductor dies 1120, 1130, 1140 and 1150 from the memory controller and operate independently in one of the normal mode, the read-only mode and the write-only mode for each DRAM semiconductor die.

In some example embodiment, as illustrated in FIG. 22, each DRAM semiconductor die may include a plurality of mode controllers MCN corresponding to the channels CH0˜CH7, for example, eight mode controllers MCN corresponding to eight channels CH0˜CH7. In this case, the high bandwidth memory 1100 receives mode information MI for each of a plurality of channels CH0˜CH7 from the memory controller and may operate independently in one of the normal mode, the read-only mode, and the write-only mode for each channel.

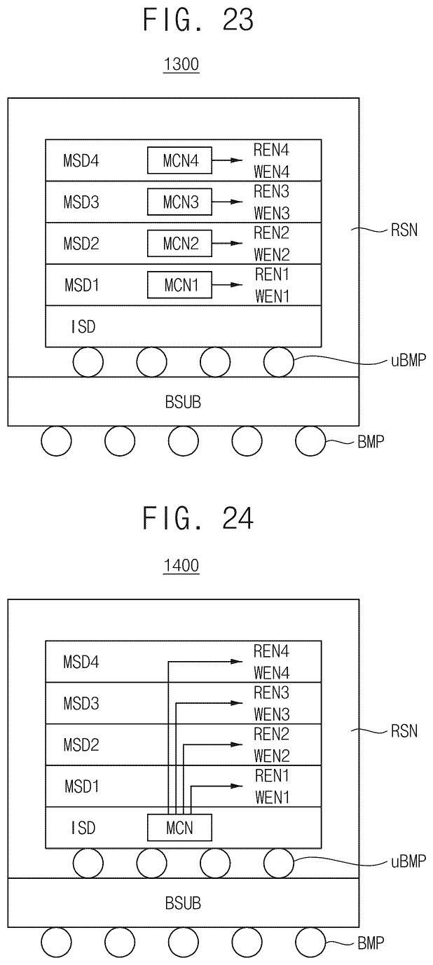

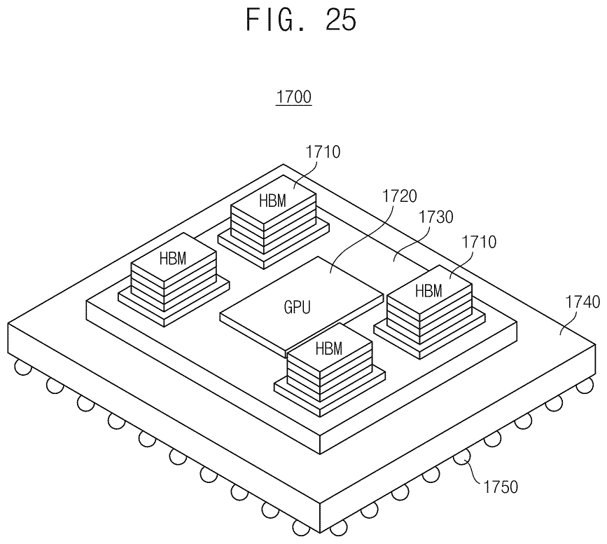

FIGS. 23 and 24 illustrate a packaging structure of a stacked memory device according to example embodiments.

Referring to FIGS. 23 and 24, the stacked memory device may be implemented in the form of memory chips 1300 and 1400. The memory chips 1300 and 1400 include a base substrate BSUB and a stacked memory device mounted on the base substrate BSUB. The stacked memory device includes an interface semiconductor die ISD and a plurality of memory semiconductor dies MSD1, MSD2, MSD3, AND MSD4. FIGS. 23 and 24 illustrate a structure in which an interface semiconductor die ISD is vertically stacked together with the memory semiconductor dies MSD1, MSD2, MSD3, AND MSD4.

The base substrate BSUB may include an interposer. The base substrate BSUB may be a printed circuit board (PCB). An external connection member, such as a conductive bump BMP, may be formed on the lower surface of the base substrate BSUB, and a conductive micro bump uBMP may be formed on the upper surface of the base substrate BSUB. The semiconductor dies ISD and MSD1, MSD2, MSD3, AND MSD4 stacked in this manner may be packaged using sealing materials RSN.

FIG. 23 illustrates an example embodiment in which a plurality of memory semiconductor dies MSD1, MSD2, MSD3, AND MSD4) each include a plurality of mode controllers MCN1, MCN2, MCN3, AND MCN4, respectively. In this case, the plurality of mode controllers MCN1, MCN2, MCN3, AND MCN4 may generate a plurality of read-only mode enable signals REN1, REN2, REN3, AND REN4 and a plurality of write-only mode enable signals WEN1, WEN2, WEN3, WEN4 corresponding to the plurality of memory semiconductor dies MSD1, MSD2, MSD3, AND MSD4, respectively.

FIG. 24 illustrates an example embodiment in which an interface semiconductor die ISD includes one common mode controller MCN. In this case, a plurality of read-only mode enable signals REN1, REN2, REN3, AND REN4 and a plurality of write-only mode enable signals WEN1, WEN2, WEN3, WEN4 generated from the common mode controller MCN may be provided to the plurality of memory semiconductor dies MSD1, MSD2, MSD3, AND MSD4, respectively.

FIG. 25 is a structural diagram illustrating an example embodiment of a semiconductor package including a semiconductor memory device according to example embodiments.

Referring to FIG. 25, a semiconductor package 1700 may include one or more stacked memory devices 1710 and a graphics processing unit (GPU) 1720. The stacked memory devices 1710 and the GPU 1720 may be mounted on an interposer 1730, and the interposer 1730 on which the stacked memory devices 1710 and the GPU 1720 are mounted may be mounted on a package substrate 1740. The GPU 1720 may perform substantially the same function as the aforementioned memory controller or may include a memory controller therein. The GPU 1720 may store data generated or used in graphic processing in one or more stacked memory devices 1710.

The stacked memory device 1710 may be implemented in various forms, and according to an example embodiment, the stacked memory device 1710 may be a memory device in the form of a high bandwidth memory (HBM) in which a plurality of layers are stacked.

Accordingly, the stacked memory device 1710 may include a buffer semiconductor die and a plurality of core semiconductor dies.

According to example embodiments, the stacked memory device 1710 may have a configuration for implementing a read-only mode ROM and a write-only mode WOM as described above.

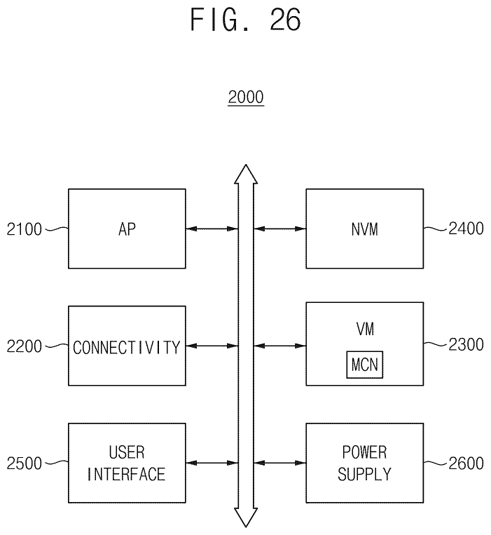

FIG. 26 is a block diagram illustrating a mobile system including a semiconductor memory device according to example embodiments.

Referring to FIG. 26, a mobile system 2000 includes an application processor 2100, a connectivity unit 2200, a semiconductor memory device 2300, a nonvolatile semiconductor memory device 2400, a user interface 2500 and a power supply 2600. According to example embodiments, the mobile system 2000 may be any mobile system, such as a mobile phone, a smart phone, a personal digital assistant (PDA), a portable multimedia player (PMP), a digital camera, a music player, a portable game console, a navigation system, etc. The application processor 2100 may execute applications that provide an Internet browser, a game, a video, etc. The connectivity unit 2200 may perform wireless or wired communication with an external device. The semiconductor memory device 2300 may store data processed by the application processor 2100 or may operate as a working memory.

The nonvolatile semiconductor memory device 2400 may store user data and a boot image for booting the mobile system 2000. The user interface 2500 may include one or more input devices such as a keypad, a touch screen, and/or one or more output devices such as a speaker, a display device. The power supply 2600 may supply an operation voltage of the mobile system 1200.

According to example embodiments, the semiconductor memory device 2300 may include a mode controller MCN as described above and may have a configuration for implementing a read-only mode ROM and a write-only mode WOM. As described above, the semiconductor memory device and memory system according to example embodiments may reduce standby power of unnecessary circuits and reduce power consumption of the semiconductor memory device and memory system by dynamically varying the operation mode of the semiconductor memory device according to the type of access to the semiconductor memory device.

The inventive concept may be applied to any electronic devices and systems. For example, the inventive concept may be applied to systems such as a memory card, a solid state drive (SSD), an embedded multimedia card (eMMC), a universal flash storage (UFS), a mobile phone, a smart phone, a personal digital assistant (PDA), a portable multimedia player (PMP), a digital camera, a camcorder, a personal computer (PC), a server computer, a workstation, a laptop computer, a digital TV, a set-top box, a portable game console, a navigation system, a wearable device, an internet of things (IoT) device, an internet of everything (IoE) device, an e-book, a virtual reality (VR) device, an augmented reality (AR) device, a server system, an automotive driving system, etc.

The foregoing is illustrative of example embodiments and is not to be construed as limiting thereof. Although a few example embodiments have been described, those skilled in the art will readily appreciate that many modifications are possible in the example embodiments without materially departing from the present inventive concept.

What is claimed is:

1. A semiconductor memory device comprising:
a plurality of memory cells;
a plurality of peripheral circuits configured to perform a write operation comprising storing write data transmitted from a memory controller into the plurality of memory cells and a read operation comprising reading out read data of data stored in the plurality of memory cells to transfer the read data to the memory controller; and
a mode controller configured to receive mode information from the memory controller, and, based on the mode information from the memory controller, control the plurality of peripheral circuits to operate in one of a normal mode for performing both the write operation and the read operation, a read-only mode for performing the read operation without performing the write operation, or a write-only mode for performing the write operation without performing the read operation.

2. The semiconductor memory device of claim 1, wherein the plurality of peripheral circuits comprises mode registers configured to store control values for controlling operations of the semiconductor memory device, and
wherein the semiconductor memory device is configured to receive the mode information through a mode register write command transmitted from the memory controller and is configured to store the mode information in a first mode register of the mode registers.

3. The semiconductor memory device of claim 2, wherein the mode controller is configured to generate both a read-only mode enable signal indicating the read-only mode and a write-only mode enable signal indicating the write-only mode based on the mode information stored in the first mode register.

4. The semiconductor memory device of claim 1, wherein the plurality of peripheral circuits comprise:
read-only circuits that are used for the read operation and not for the write operation; and
write-only circuits that are used for the write operation and not for the read operation.

5. The semiconductor memory device of claim 4, wherein the mode controller, based on the mode information, is configured to disable the write-only circuits in the read-only mode and is configured to disable the read-only circuits in the write-only mode.

6. The semiconductor memory device of claim 4, wherein the mode controller, based on the mode information, is configured to disable a first clock signal applied to the write-only circuits in the read-only mode, and is configured to disable a second clock signal applied to the read-only circuits in the write-only mode.

7. The semiconductor memory device of claim 4, wherein the mode controller, based on the mode information, is configured to block a power supply voltage applied to the write-only circuits in the read-only mode, and is configured to block a power supply voltage applied to the read-only circuits in the write-only mode.

8. The semiconductor memory device of claim 1, wherein the plurality of peripheral circuits comprise:
reception circuits configured to receive the write data transmitted from the memory controller; and
transmission circuits configured to transmit the read data to the memory controller, and
wherein the mode controller, based on the mode information, is configured to disable the reception circuits in the read-only mode, and is configured to disable the transmission circuits in the write-only mode.

9. The semiconductor memory device of claim 1, wherein the plurality of peripheral circuits comprises:
an error check code (ECC) encoder configured to perform ECC encoding on the write data; and
an ECC decoder configured to perform ECC decoding on the read data,
wherein the mode controller, based on the mode information, is configured to disable the ECC encoder in the read-only mode and is configured to disable the ECC decoder in the write-only mode.

10. The semiconductor memory device of claim 1, wherein the mode information comprises a first bit indicating the read-only mode and a second bit indicating the write-only mode.

11. The semiconductor memory device of claim 10, wherein the mode information indicates the normal mode when both the first bit and the second bit have a first value, indicates the read-only mode when the first bit has a second value different from the first value, and indicates the write-only mode when the second bit has the second value.

12. The semiconductor memory device of claim 10, wherein the mode controller comprises:
a first signal generator configured to, based on a first clock signal and the first bit, generate a read-only mode enable signal that is activated during the read-only mode; and
a second signal generator configured to, based on a second clock signal and the second bit, generate a write-only mode enable signal that is activated during the write-only mode.

13. The semiconductor memory device of claim 12, wherein the plurality of peripheral circuits comprises:
read-only circuits that are used for the read operation and not used for the write operation; and
write-only circuits that are used for the write operation and not for the read operation;
a first voltage switch circuit configured to block a power supply voltage applied to the read-only circuits in response to activation of the write-only mode enable signal; and
a second voltage switch circuit configured to block a power supply voltage applied to the write-only circuits in response to activation of the read-only mode enable signal.

14. The semiconductor memory device of claim 12, wherein the plurality of peripheral circuits comprises:
read-only circuits that are used for the read operation and not used for the write operation; and
write-only circuits that are used for the write operation and not for the read operation;
a first clock gating circuit configured to disable a third clock signal applied to the read-only circuits in response to activation of the write-only mode enable signal; and
a second clock gating circuit configured to disable a fourth clock signal applied to the write-only circuits in response to activation of the read-only mode enable signal.

15. The semiconductor memory device of claim 1, wherein the plurality of memory cells correspond to dynamic random access memory (DRAM) cells and the semiconductor memory device corresponds to a DRAM device.

16. The semiconductor memory device of claim 1, wherein the mode controller is configured to receive an active command, a read command, a refresh command and a mode register write command and other commands are not received in the read-only mode, and
wherein the mode controller is configured to receive the active command, a write command, the refresh command and the mode register write command and other commands are not received in the write-only mode.

17. The semiconductor memory device of claim 1, wherein the plurality of memory cells are distributed in a plurality of memory semiconductor dies, and
wherein the semiconductor memory device is configured to receive the mode information respectively for each of the plurality of memory semiconductor dies from the memory controller, and each of the plurality of memory semiconductor die independently operates in one of the normal mode, the read-only mode, or the write-only mode.

18. The semiconductor memory device of claim 1, wherein the plurality of memory cells are grouped into a plurality of channels that are independently accessed, and
wherein the semiconductor memory device is configured to receive the mode information respectively for each of the plurality of channels from the memory controller, and each of the plurality of channels independently operates in one of the normal mode, the read-only mode, or the write-only mode.

19. A memory system comprising:
a semiconductor memory device; and
a memory controller configured to control the semiconductor memory device,
wherein the semiconductor memory device comprises:
a plurality of memory cells;
a plurality of peripheral circuits configured to perform a write operation comprising storing write data transmitted from the memory controller into the plurality of memory cells and a read operation comprising reading out read data of data stored in the plurality of memory cells to transfer the read data to the memory controller; and
a mode controller configured to receive mode information from the memory controller, and, based on the mode information from the memory controller, control the plurality of peripheral circuits to operate in one of a normal mode for performing both the write operation and the read operation, a read-only mode for performing the read operation without performing the write operation, or a write-only mode for performing the write operation without performing the read operation, and
wherein the memory controller is configured to provide the semiconductor memory device with the mode information indicating one of the normal mode, the read-only mode or the write-only mode, based on an access type with respect to the semiconductor memory device.

20. A semiconductor memory device comprising:
a plurality of dynamic random access memory (DRAM) cells;
read-only circuits that are used for a read operation comprising reading out read data of data stored in the plurality of DRAM cells to transfer the read data to a memory controller and are not used for a write operation comprising storing write data transmitted from the memory controller into the plurality of DRAM cells;
write-only circuits that are used for the write operation and are not used for the read operation; and
a mode controller configured to receive mode information from the memory controller, and, based on the mode information from the memory controller, enable both the read-only circuits and the write-only circuits in a normal mode that performs both the write operation and the read operation, disable the write-only circuits in a read-only mode that performs the read operation without performing the write operation, or disable the read-only circuits in a write-only mode that performs the write operation without performing the read operation,.
